(19) United States
(12) Patent Application Publication
(10) Pub. No.: US 2014/0201366 A1
(43) Pub. Date: Jul. 17, 2014

(54) SMARTPHONE APPS IN A CLOUD

(71) Applicant: TELEFONAKTIEBOLAGET L M ERICSSON (PUBL), Stockholm (SE)

(72) Inventor: Andre Kamp, Aachen (DE)

(73) Assignee: Telefonaktiebolaget L M Ericsson (publ), Stockholm (SE)

(21) Appl. No.: 14/118,388

(22) PCT Filed: Sep. 29, 2011
(86) PCT No.: PCT/EP2011/004876

§ 371 Date: Feb. 21, 2014

Related U.S. Application Data
(60) Provisional application No. 61/487,528, filed on May 18, 2011.

(51) Int. Cl. H04L 29/06

(52) U.S. Cl. CPC H04L 63/10
USPC 709/225

(57) ABSTRACT

The present disclosure relates to a technique of providing/obtaining remote access from a mobile terminal to a plurality of applications hosted in a network. A method embodiment comprises the steps of determining, by an authentication server, based on authentication information received from the mobile terminal, whether to allow remote access from the mobile terminal to the network, and providing, by the authentication server, remote access from the mobile terminal to the plurality of applications hosted in the network, if it is determined that the remote access is allowed, wherein the remote access allows executing the plurality of applications in the network.

### TECHNICAL FIELD

The invention generally relates to the field of network hosted applications. More specifically, the invention relates to a technique of providing and obtaining access to a plurality of applications hosted in a network.

### BACKGROUND

Applications for mobile terminals and small low-power handheld devices such as personal digital assistants (PDAs), handheld computers, enterprise digital assistants (EDAs), Tablet Personal Computers (Tablet PCs), notebooks or mobile phones like smartphones are becoming increasingly important. These applications are either pre-installed on mobile phones (or other mobile terminals) during manufacture or downloaded by customers from various mobile software distribution platforms (digital distribution platforms). These applications are often only referred to as “apps”. Likewise, the distribution platforms are often generally referred to as “app stores”. Normally, each platform contains applications of one operating system running on the mobile terminal which connects to the platform. That is, a user of a mobile terminal on which operating system X is running, will connect to the platform having applications suitable for the operating system X. A different or the same user will, however, connect to the platform having applications suitable for the operating system Y when using a mobile terminal on which operating system Y is running.

The so called “app stores” like Google's Android Market™ or Apple's® iPhone App Store^{SM} are growing rapidly. These stores are basically a big software storage and offer some hundred thousand downloadable applications for mobile phones. The amount of available applications—also known as “apps”—is increasing constantly. Right now, end users download these apps to their clients which are in most cases mobile phones or Tablet PCs. In order to use an app, the client usually establishes an internet connection and connects to the service provider to retrieve the contents for a specific app.

After the download of applications from the respective platform, the downloaded applications can be installed on the client and can then be executed on the client. This approach can be considered a client-centric approach.

The current client-centric approach which requires the download of an app to the client comes along with some problems and disadvantages. These disadvantages are sketched in the following.

Assume that an end user owns several clients, e.g. one Tablet PC and one smartphone. On both clients, the end user wants to use one and the same app. This app then has to be downloaded to each of the clients. In order to use that app with the same configurations, the configuration procedure also has to be performed twice in this case—one time per each device. This is very inconvenient for the users.

When there is an update or a new version available for a specific app, the end user then again has to download the app to all of the end user's devices and configure the apps in the same way. That means, in order to always have the latest version of an app available, the end user has to take care of this manually by downloading the newest version to the client.

The current client based approach becomes even more inconvenient if the clients are running different operating systems like Google's Android (e.g. on the Sony Ericsson Xperia 10) or Apple's iOs (e.g. on iPhone or iPad). The end user then has to access different app stores for the same app depending on the clients' operating systems.

Another disadvantage shows up when one client is used by different end users. For example, a Tablet PC is used by two end users A and B. End user A wants to use another set of apps than end user B. The only solution right now is to install all apps—the ones for end user A and B—onto the Tablet PC to have all apps available on the client and to serve both users' needs. In other words, the resources of the client like memory and CPU are not efficiently used.

Finally, if one end user wants to use different sets of apps e.g. depending on the daytime or if the user is at work or home, right now the user always has to have the whole set of apps available on the client, although many of the installed apps might not be used at that moment. Also here, memory resources could be used more efficient.

These disadvantages, which are sketched above, can be avoided with the invention described in the present document. The present invention described in the following sections solves the above problems. The present invention may further not require to always have all apps installed but may obtain/provide access only to the ones needed at a specified point in time.

### SUMMARY

Accordingly, there is a need for an improved and more efficient technique for obtaining/providing access to applications.

The basic concept of the present disclosure is to host and execute the apps in the network rather than on the client side (e.g., on a mobile terminal) and to make the apps available as Software as a Service (SaaS) in a cloud environment. SaaS is a software delivery model in which software and its associated data are hosted centrally (typically in the cloud) and are accessed by users using a client, normally using a web browser over the Internet. On the client, only one operating system native master app (master application) needs to be installed which connects to the network and accesses and displays the contents of the apps.

According to a first aspect, a method of providing remote access from a mobile terminal to a plurality of applications hosted in a network is provided. The method comprises the steps of: determining, by an authentication server, based on authentication information received from the mobile terminal, whether to allow remote access from the mobile terminal to the network; and providing, by the authentication server, remote access from the mobile terminal to the plurality of applications hosted in the network, if it is determined that the remote access is allowed, wherein the remote access allows executing the plurality of applications in the network.

The authentication server may reside between the mobile terminal trying to obtain access to the applications hosted in the network and the network itself. A user trying to access the applications hosted in the network may use the master application installed on the mobile terminal to connect to the authentication server. The authentication server may determine which mobile terminal or user is trying to obtain remote access. The user may input identification information identifying himself/herself to the authentication server. Alternatively, the authentication server may automatically determine the user based on information related to the mobile terminal or master application the user is using. The input or determined information may be used in order to derive the authentication information.

The authentication information may comprise information based on which it can be determined by the authentication server, whether the mobile terminal or the user of the mobile terminal is allowed to obtain remote access to the applications hosted in the network. For example, the authentication information may be based on or derived from information input by the user, like a user name and a password. If the remote access is allowed, the authentication server may establish a remote connection between the mobile terminal and the network. The mobile terminal may then access and execute the applications hosted in the network via the remote connection. For example, a user may select any one of the applications hosted in the network via the master app installed on the mobile terminal and may then execute the selected application in the network rather than on the mobile terminal. In this way, there is no need to download the selected application to the mobile terminal, but the selected application can be executed in the network itself.

In accordance with one variant of the first aspect, the steps of determining and providing remote access may be implemented as: determining, by the authentication server, based on the authentication information, a set of applications, wherein the set of applications comprises one or more of the plurality of applications hosted in the network; and providing, by the authentication server, remote access from the mobile terminal only to the one or more applications contained in the set of applications. According to the variant of the first aspect, the authentication server may not allow remote access to all of the plurality of applications hosted in the network, but may only allow, by considering the authentication information, remote access to the set of applications hosted in the network. If it is determined by the authentication server, by considering the authentication information, to allow only remote access to the set of applications, the authentication server will only allow the mobile terminal to remotely access the one or more applications contained in the set, rather than to remotely access applications which are hosted in the network but which are not contained in the set of applications. The applications contained in the set, to which the remote access is allowed, can then be executed by the mobile terminal in the network. The further applications, to which remote access is not allowed, i.e., the applications which are not contained in the set, cannot be accessed and executed by the mobile terminal.

There are multiple possible realizations how the authentication server can determine the set of applications. In all realizations, one or more (e.g., a plurality of) sets of applications may be maintained, e.g. stored, in the authentication server and the set of applications may be determined from the one or more (e.g., the plurality of) sets of applications maintained in the authentication server.

According to a first realization of the variant, the step of determining the set of applications may comprise determining the set of applications from the one or more (e.g., the plurality of) sets of applications maintained in the authentication server based on the authentication information. For example, the authentication server may automatically determine, from the one or more (e.g., the plurality of) sets of applications, the set which is indicated by the authentication information. In this first realization, no further user input may be required in order to select the correct set of applications.

According to a second realization of the variant, the step of determining the set of applications may comprise choosing the set of applications from the one or more sets of applications based on a user input of a user of the mobile terminal. By means of the user input, a user of the mobile terminal may search, e.g. scroll, through the sets of applications maintained in the authentication server and may select the one he/she is interested in. The second realization may be based only on the user input.

According to a third realization of the variant, the step of determining the set of applications may comprise both determining the set of applications from the one or more (e.g., the plurality of) sets of applications maintained in the authentication server based on the authentication information and choosing the set of applications from the one or more sets of applications based on a user input of a user of the mobile terminal. In this context, the third realization may comprise two steps. In a first step, the authentication server may determine at least one candidate set of applications from the one or more sets of applications hosted in the network based on the authentication information. The at least one determined candidate set of applications may be determined as a candidate because it is related to the mobile terminal or the user accessing the authentication server. In a second step, the user may then search, e.g. scroll, through the determined at least one candidate set of applications previously determined by the authentication server and may then select the appropriate set from the at least one candidate set. In this way, the third realization comprises both automatic pre-selection by the authentication server and a final user selection by way of a user input.

At least a subset of the one or more sets of applications maintained in the authentication server may comprise different ones of the plurality of applications hosted in the network. Alternatively or additionally, at least a subset of the one or more sets of applications comprises the same of the plurality of applications hosted in the network. It is, for example, conceivable that a plurality of sets of applications assigned to multiple users or terminals is maintained in the authentication server. One or more of the plurality of applications hosted in the network may be part of two or more sets of applications maintained in the authentication server. In this way, a subset of the sets of applications maintained in the authentication server may share one or more applications. Alternatively or additionally, one or more of the plurality of applications hosted in the network may be exclusive for only one set of applications maintained in the authentication server.

In one implementation, the one or more sets of applications may be defined in user accounts established for users of mobile terminals. For example, each user of a mobile terminal may create a user account in the mobile terminal he/she is using, e.g. by means of the master application. In other words, the user account may be specific to a user of the mobile terminal and may be maintained in the authentication server. The user account may then indicate to which applications the corresponding user shall have remote access. For example, each end user has a user account to get authorized to the network hosting the apps. The user account allows the definition and configuration of the set of apps which shall be remotely available on the client.

In addition, the user may create one or more user profiles in the user account. In case one or more user profiles are created, each of the one or more sets of applications may be predefined in a user profile of the user account. Applying different user profiles per user account offers the possibility to have different sets of apps available on a client at different points in time. The different user profiles of one user account may be created based on different time, location or any other type of parameter.

The applications to which remote access shall be allowed for each user profile may be automatically suggested or defined by the authentication server. For this purpose, the authentication server may consider the user's needs (as e.g. input by the user) or the typical or average user behavior when using the specific mobile terminal. Alternatively or additionally, the user may configure the applications to which remote access shall be allowed for each user profile.

If it is determined, by the authentication server, that remote access is allowed, the remote access is provided from the mobile terminal to the plurality of applications hosted in the network. The remote access may be provided according to multiple possible realizations. In accordance with one realization, the step of providing remote access may include the steps of requesting, by the authentication server, connecting data to the plurality of applications hosted in the network, if it is determined that the remote access is allowed, retrieving, by the authentication server, the connecting data to the applications hosted in the network and transmitting, by the authentication server, the retrieved connecting data to the mobile terminal. For example, if a user of a mobile terminal has a user account created on his/her mobile terminal, the authentication server may identify the authentication information contained in or provided by the user account and may then retrieve the connecting data to the applications, which the user is allowed to access in accordance with the authentication information. The respective retrieved connecting data may then be transmitted to the mobile terminal, so that the user may be allowed to access only the applications for which he/she has received the connecting data from the authentication server.

As stated above, the user corresponding to a user account can create one or more user profiles for the user account. Each user profile may be configured differently, i.e. may contain a different set of applications (although some applications may be contained in more than one of the user profiles). In this respect, the step of requesting connecting data may comprise the step of requesting, by the authentication server, only the connecting data to the applications contained in the set of applications indicated by the selected user account.

For example, a user may log into its user account and may select a first user profile from the multiple created or configured user profiles for the user account. The authentication server may then determine from the authentication information derived from the selected first user profile that the user corresponding to the selected first user profile is allowed to access only the set of applications identified by the first user profile. Then, the authentication server only retrieves the connecting data corresponding to the identified set of applications and may forward the retrieved connecting data to the mobile terminal. The mobile terminal may then remotely access the applications for which the connecting data has been received, but cannot remotely access the further applications. The user may subsequently select a second user profile from the user profiles contained in his/her user account, e.g. by using the same or a different mobile terminal. The authentication server may then determine from the authentication information derived from the selected second user profile that the user corresponding to the selected second user profile is allowed to access only the set of applications identified by the second user profile. Then, the authentication server only retrieves the connecting data corresponding to the identified set of applications and may forward the retrieved connecting data to the mobile terminal. The mobile terminal may then remotely access the applications for which the connecting data has been received, but cannot remotely access the further applications. By way of different user profiles the same user having the same user account may obtain access to different applications.

After having remote access to one, some or all of the applications hosted in the network, the mobile terminal can, by way of the remote access, execute the respective application(s) (in the network) to which remote access is obtained.

According to a second aspect, a method of obtaining remote access from a mobile terminal to a plurality of applications hosted in a network is provided. The method comprises the steps of: requesting, by the mobile terminal, remote access to the plurality of applications hosted in the network by signaling authentication information; and obtaining, by the mobile terminal, remote access to the plurality of applications hosted in the network, if it is determined, based on the authentication information, that remote access is allowed, wherein the remote access allows executing the plurality of applications in the network.

All aspects described above with respect to the method according to the first aspect correspondingly apply to the method according to the first aspect.

Further to the foregoing steps of the method according to the second aspect, the method may comprise the step of executing, by the mobile terminal, one of the plurality of applications in the network after obtaining remote access to the plurality of applications. In this context, it may only be possible for the mobile terminal to execute an application to which remote access has been allowed. The applications to which remote access has not been allowed cannot be executed by the mobile terminal.

According to one realization of the second aspect, the method may further comprise the step of creating, by the mobile terminal, a user account in the authentication server, wherein the user account is accessible by means of the authentication information. In this context, the user may, when using his/her mobile terminal, access the created user account by inputting the authentication information. The authentication information may then be forwarded from the mobile terminal to the authentication server, when the user wishes to obtain access to the applications hosted in the network. Based on the authentication information, the authentication server may decide whether to allow remote access to all or only some (e.g., only one) of the applications hosted in the network.

The step of creating the user account may further comprise creating one or more user profiles in the user account. Each of the one or more user profiles may specify a set of applications comprising one or more of the plurality of applications hosted in the network. The one or more applications may be automatically specified by the authentication server based on the user behaviour of the user. Alternatively or additionally, the user may select one or more applications available in the network. When the user is trying to obtain remote access, he/she logs into his/her user account by using his/her authentication information. The user may then select from the one or more user profiles of the user account, one user profile. In accordance with the selected user profile, the authentication server may determine the applications which are indicated by the user profile. The authentication server may then retrieve, from the network, the connecting data for the determined applications and may forward the connecting data for the determined applications to the mobile terminal. The user may then choose one of the determined applications and may execute the chosen application in the network, e.g. by using the master application running on the mobile terminal.

According to a third aspect, a computer program product is proposed, comprising program code portions for performing steps of any one of the method aspects described herein, when the computer program product is run on one or more computing devices. The computer program product may be stored on a computer readable recording medium.

According to a fourth aspect, an authentication server for providing remote access from a mobile terminal to a plurality of applications hosted in a network is provided. The authentication server comprises: a determining component for determining based on authentication information received from the mobile terminal, whether to allow remote access from the mobile terminal to the network; and a remote access component for providing remote access from the mobile terminal to the plurality of applications hosted in the network, if it is determined that the remote access is allowed, wherein the remote access allows executing the plurality of applications in the network.

The determining component may be further adapted to determine based on the authentication information, a set of applications, wherein the set of applications comprises one or more of the plurality of applications hosted in the network, and the remote access component may be further adapted to provide remote access from the mobile terminal only to the one or more applications contained in the set of applications.

The server may further comprise a storing component for maintaining one or more sets of applications and the determining component may be further adapted to at least one of determine the set of applications from the one or more sets of applications based on the authentication information and to receive a user input of a user of the mobile terminal for choosing the set of applications from the one or more sets of applications. The storage component may be further adapted to maintain one or more user profiles of a user account, wherein the user account is specific to a user of the mobile terminal and each of the one or more user profiles specifies one of the one or more sets of applications.

The remote access component may be further adapted to request connecting data to the plurality of applications hosted in the network, if it is determined that the remote access is allowed, to retrieve the connecting data to the applications hosted in the network and to transmit the retrieved connecting data to the mobile terminal.

According to a fifth aspect, a mobile terminal for obtaining remote access to a plurality of applications hosted in a network is provided. The mobile terminal comprises: a requesting component for requesting remote access to the plurality of applications hosted in the network by signaling authentication information; and an obtaining component for obtaining remote access to the plurality of applications hosted in the network, if it is determined, based on the authentication information, that remote access is allowed, wherein the remote access allows executing the plurality of applications in the network.

The mobile terminal may further comprise an executing component for executing one of the plurality of applications hosted in the network.

According to a sixth aspect, a system for providing remote access from a mobile terminal to a plurality of applications hosted in a network is provided. The system comprises: the network hosting a plurality of applications; the authentication server according to the fourth aspect as previously described; and the mobile terminal according to the fifth aspect as previously described.

### BRIEF DESCRIPTION OF THE DRAWINGS

In the following, the invention will further be described with reference to exemplary embodiments illustrated in the figures, in which:

FIG. 1 is a schematic illustration of a system comprising two mobile terminals, an authentication server and a network;

FIG. 2 is a schematic illustration of a device embodiment of the authentication server of FIG. 1;

FIG. 3 is a schematic illustration of a second device embodiment of one of the mobile terminals shown in FIG. 1;

FIG. 4 is a schematic illustration of a first method embodiment performed in the first device embodiment of FIG. 2;

FIG. 5 is a schematic illustration of a second method embodiment performed in the second device embodiment of FIG. 3; and

FIG. 6 is a schematic illustration of a third method embodiment.

### DETAILED DESCRIPTION

In the following description, for purposes of explanation and not limitation, specific details are set forth, such as specific network topologies including particular network nodes, communication protocols etc., in order to provide a thorough understanding of the present invention. It will be apparent to one skilled in the art that the present invention may be practiced in other embodiments that depart from these specific details. For example, the skilled person will appreciate that the present invention may be practiced with any application which can be executed by a mobile terminal. Further, although the examples below will be explained with respect to Hypertext Transfer Protocol (HTTP) authentication, other authentication techniques can be used instead or in addition. Also, the applications may be hosted by any network to which mobile or stationary users may attach. For example, the invention is applicable to, besides cellular networks, WLAN, Bluetooth, DVB or similar wireless networks, but also to wireline networks such as, for example, the intranet of a company with some or many separated subsidiaries or the Internet.

Those skilled in the art will further appreciate that functions explained hereinbelow may be implemented using individual hardware circuitry, using software functioning in conjunction with a programmed microprocessor or a general purpose computer, using an application specific integrated circuit (ASIC) and/or using one or more digital signal processors (DSPs). It will also be appreciated that when the present invention is described as a method, it may also be embodied in a computer processor and a memory coupled to a processor, wherein the memory is encoded with one or more programs that perform the methods disclosed herein when executed by the processor.

As stated in section “Summary” above, the general idea of the disclosure is to host and execute apps developed for smartphones and Tablet PCs in the network rather than on the client. In other words, the present disclosure proposes a new way of accessing and using apps which offers quite some improvements and advantages compared to current solutions.

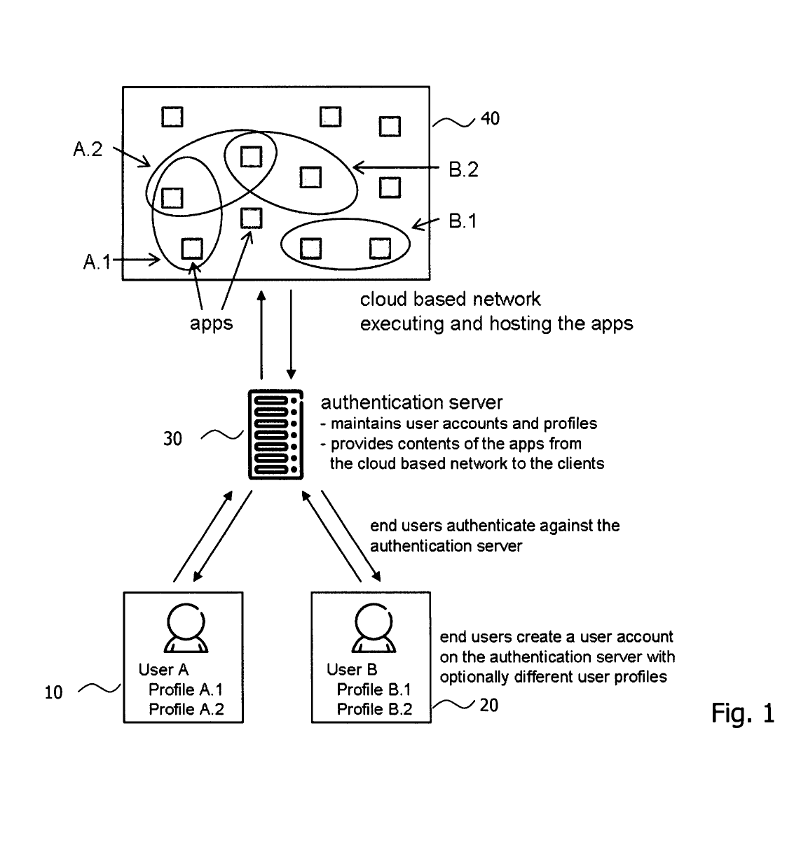

FIG. 1 illustrates the architecture of particular embodiments and shall be used to provide a detailed technical description:

FIG. 1 schematically shows two mobile terminals as user clients, namely a first mobile terminal 10 and a second mobile terminal 20. As exemplarily illustrated in FIG. 1, user A is using the first mobile terminal 10 as its user client and user B is using the second mobile terminal 20 as its user client. The mobile terminals 10, 20 may be any mobile device capable of wireline or wireless communication techniques. In this respect, the mobile terminals 10, 20 may be mobile phones (e.g., smartphones), laptops, Tablet PCs, PDAs or the like. The mobile phones may be User Equipments (UEs) suitable for communicating in the Universal Mobile Telecommunications System (UMTS), 3GPP Long Term Evolution (LTE) or LTE advanced environment and/or may be mobile terminals suitable for communication in a Global System for Mobile Communications (GSM) environment.

Both mobile terminals 10, 20 can establish a connection, e.g. a wireless connection, with an authentication server 30. The authentication server 30 itself can establish a connection, e.g. a wireline or wireless connection, with a network 40 which is in FIG. 1 exemplarily referred to as a cloud based network 40. A cloud based network is a network of resources which is based on the logic of cloud computing. However, the network 40 may be any network which is capable of hosting and executing applications.

As further schematically illustrated in FIG. 1, a plurality of applications Capps) are hosted in the cloud based network 40. In FIG. 1, the cloud based network 40 exemplarily hosts eleven applications. However, this number is merely exemplary due to limited space. The cloud based network 40 may host any number of applications, like several hundreds, thousands, ten thousands, hundred thousands or even millions of applications. The applications are developed for the mobile terminals 10, 20 such that they can normally be executed by the mobile terminals 10, 20. The applications are ordinary applications which could principally also be downloaded to the mobile terminals 10, 20, as known in the art, so that the downloaded applications could then be executed on the mobile terminals 10, 20 themselves.

In FIG. 1, the apps developed for smartphones and Tablet PCs are located in the network 40 and the idea is to not download them to the client, i.e. the mobile terminals 10, 20 shown in FIG. 1, but to execute them in the cloud, i.e. the network 40. The cloud based network 40 is illustrated at the top of FIG. 1. As stated above, the cloud based network 40 is a network of resources which is based on the logic of cloud computing. Cloud computing is a model for enabling on-demand network access to a shared pool of configurable computing resources (e.g., networks, servers, storage, applications, and services) that can be rapidly provisioned and released with minimal management effort or service provider interaction. This setup is known from cloud based services such as web mail or online banking. It has not been used though for provision of apps developed for smartphones and/or tablet PCs. The setup described in this disclosure allows the execution of more complex applications as the processing power in the network 40 is larger than the one on the client, i.e. the mobile terminals 10, 20.

At the bottom of FIG. 1, there are two users A and B illustrated. The users' clients, i.e. the mobile terminals 10, 20 in the exemplary configuration shown in FIG. 1, which can be a smartphone, a Tablet PC or any other type of device able to run apps, are considered to have one operating system native master app installed on their client. Through the master app, the client (one or both of the mobile terminals 10, 20) can connect to the network 40 and get access to the apps in the cloud, namely the network 40 via the authentication server 30. The apps are displayed on the client (on one or both of the mobile terminals 10, 20). The term “master app” is used to describe the software running on the client which allows connection to the apps in the cloud 40 and which handles the authentication on the client side. The authentication can be performed by providing the user credentials to the authentication server 30, which is described below. Other terms may also be used to describe the software which performs the functions of the master app.

As stated above, FIG. 1 also shows an authentication server (AS) 30 proposed by the disclosure. The key functionalities of the authentication server 30 are to maintain user accounts and to keep an overview of apps which are available in the cloud based network 40, e.g. in the form of a list. The users A and B interact with the authentication server 30 shown in FIG. 1 as described below, e.g. by means of the mobile terminals 10, 20. The users A, B create their user accounts with the help of the master app (running on each of the mobile terminals 10, 20). Each user A, B can specify an own username and a password. Via HTTP Basic or Digest Authentication, the users A, B authenticate towards the authentication server 30. The authentication server 30 then offers the authenticated users A, B the possibility to define a set of apps which shall be remotely available on the client of the user (on one the mobile terminals 10, 20). It is also possible that each user A, B defines different profiles (as exemplarily shown in FIG. 1: profiles A.1 and A.2 for user A and profiles B.1 and B.2 for user B) based on time, location or any other type of parameter. This allows the possibility to have different sets of available apps based on the different user profiles A.1, A.2, B.1, B.2.

For example, user A may have created a user account on the authentication server 30. Furthermore, user A created two profiles, A.1 and A.2, on that server as part of the user account e.g. A.1 might indicate that user A is “at work” and A.2 “at home”.

For each profile A.1, A.2, user A can choose a list of apps which shall be remotely available on the client, i.e. the mobile terminal 10. FIG. 1 illustrates that an app which belongs to the user profile A.1 may also belong to user profile A.2 of the same user. An app can also belong to profiles of different users such as profile A.2 and B.2, where B.2 is a profile created by user B. This is possible as the network 40 which hosts and executes the apps offers cloud based characteristics and services such as multi tenancy i.e. a single instance of the software runs on a server, serving multiple clients (tenants). That means, the one app can be offered to many different clients, e.g. the mobile terminals 10, 20, at the same time. The authentication server 30 can suggest a pre-defined set of apps for a user profile. In that way the user (user A and/or B) can get an idea of what the profiles can be used for. A profile “at home” may trigger provision of apps which are different to the ones provided based on the profile “at work”. This is because the needs can be different at different points in a day time. These needs can be indirectly shown by the profiles.

In other words, the different profiles A.1, A.2 of user A can be created based on different needs or user behaviour of the user A and can in this way represent the different needs or user behaviour (e.g. during day time, on different terminals and so on) of the user A. The same applies to the user profiles 6.1 and B.2 of user B.

Instead of being used by different users A, B, the mobile terminals 10, 20 may be different terminals like a mobile phone and a Tablet PC of the same user.

After a successful authentication of a user A, B towards the authentication server 30, the user A, B can then choose one of the defined user profiles A.1, A.2, B.1, B.2. Afterwards, the authentication server 30 establishes a connection to the app-hosting network 40 and provides access to the specified apps. The user's A, B master app is then allowed to connect to the apps using web and internet protocols such as HTTP and is able to access and display the contents of the apps executed in the network 40.

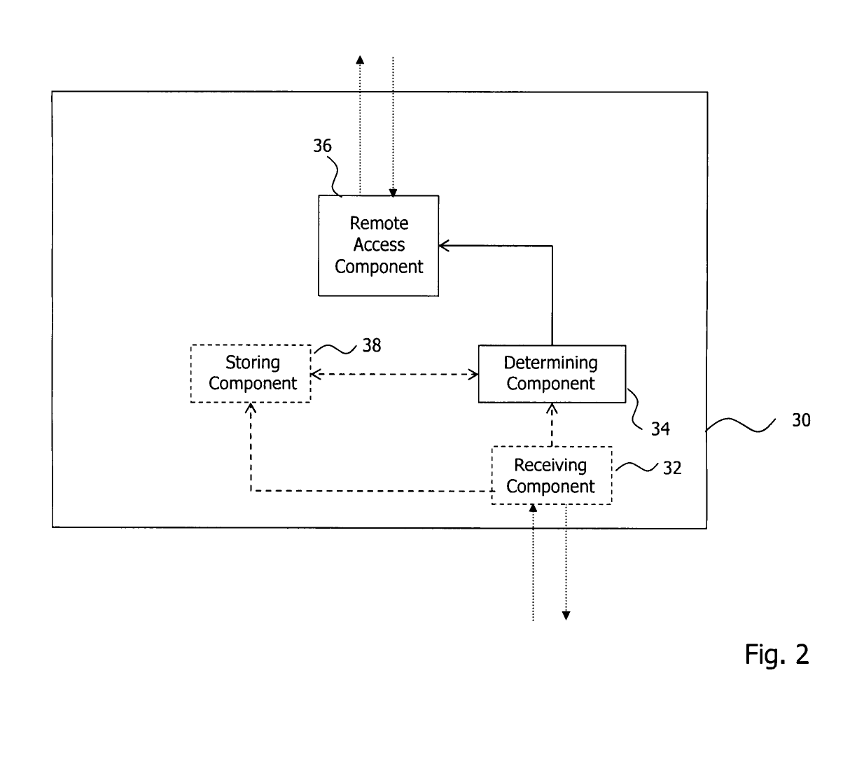

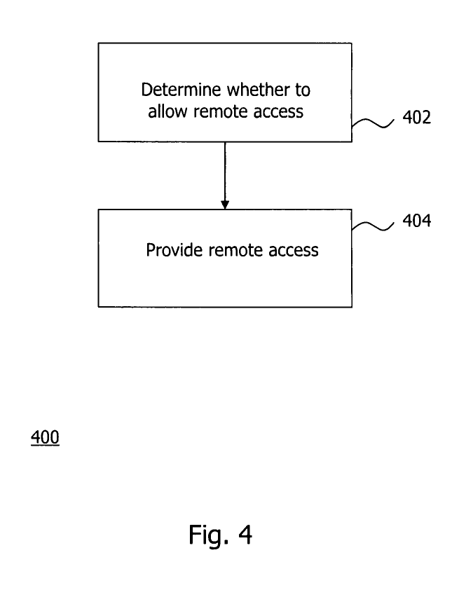

FIG. 2 schematically illustrates the authentication server 30 for providing remote access from the mobile terminals 10, 20 to the plurality of applications hosted in the network 40. The authentication server 30 comprises a determining component 34 and a remote access component 36. The authentication server 30 may further additionally comprise a receiving component 32 and a storing component 38 (the dashed lines indicate that the receiving component 32 and the storing component 38 are optional). The functionality of the authentication server 30 will be further described with respect to FIG. 4 below.

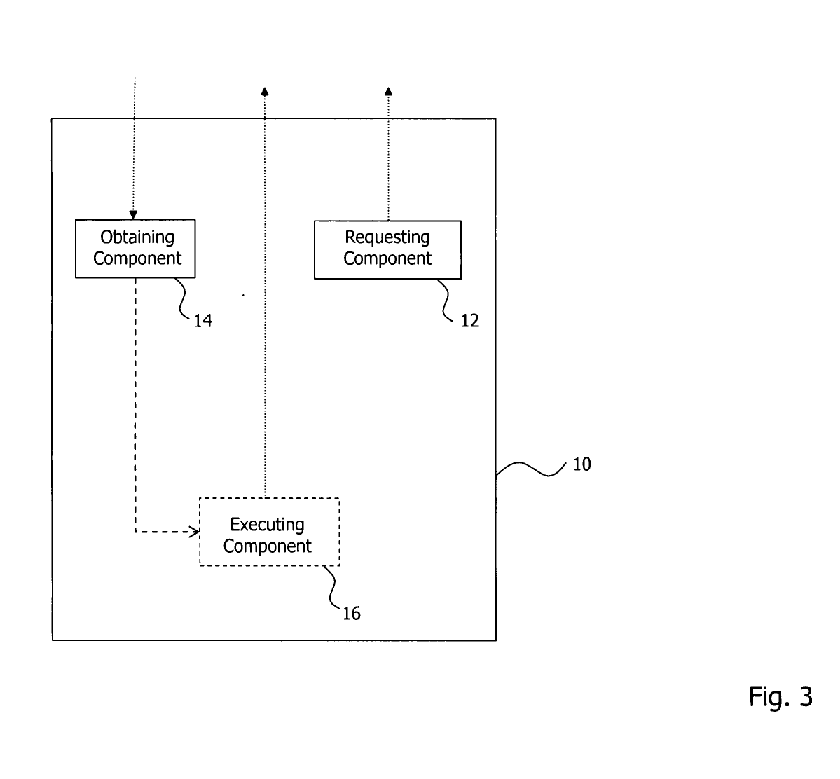

FIG. 3 schematically illustrates the mobile terminal 10 as one of the clients shown in FIG. 1. However, the mobile terminal 20 may be configured accordingly.

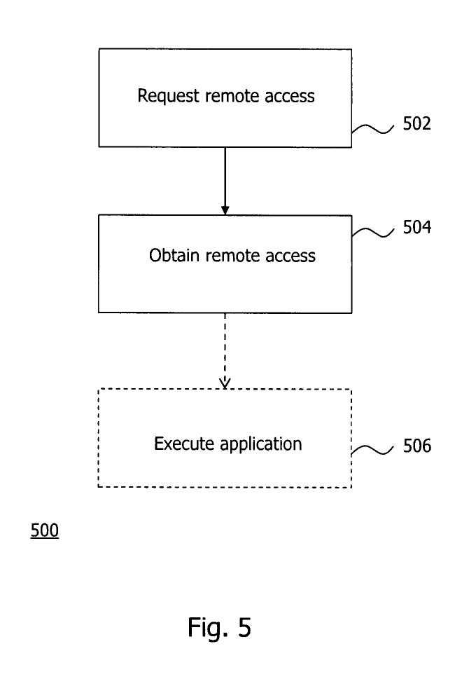

The mobile terminal 10 for obtaining remote access to the plurality of applications hosted in the network 40 comprises a requesting component 12 and an obtaining component 14. The mobile terminal 10 may further comprise an executing component 16 (the dashed lines indicate that the executing component 16 is optional). The functionality of the mobile terminal 10 will be further described with respect to FIG. 5 below.

FIG. 4 shows a first method embodiment performed in the authentication server 30 of FIG. 2.

If one of the mobile terminals 10, 20 is requesting access to the applications hosted in the network 40 (in the following it is assumed without limitation that the mobile terminal 10 is requesting access), the mobile terminal 10 is providing, e.g.

transmitting, authentication information to the authentication server 30. The authentication information serves to identify the user of the mobile terminal 10 to the authentication server 30. The receiving component 32 may receive the authentication information from the mobile terminal 10 and may forward the authentication information to the determining component 34. The determining component 34 of the authentication server 30 obtains the authentication information and is adapted to determine, in step 402, whether to allow remote access from the mobile terminal 10 requesting access to the network 40. For determining the foregoing, the determining component 34 considers the authentication information provided by the mobile terminal 10.

The determining component 32 may further be in connection with the storing component 38. If it is determined in step 402 that remote access is allowed, the determining component 34 may compare the authentication information with a plurality of authentication information stored in the storing component 38. The plurality of authentication information stored in the storing component 38 may be a plurality of different user profiles stored for different users which have submitted their user profiles to the authentication server. In other words, the storing component 38 may comprise all user profiles of users which have previously created user accounts with user profiles and have submitted these user profiles to the storing component 38. The plurality of authentication information (e.g., the user accounts and user profiles) may be submitted by the users to the storing component 38 via the receiving component 32. For example, a user can submit his/her user profiles to the receiving component 32 which can then forward this information to the storing component 38. In this way, a plurality of user profiles can be received by the receiving component 32 and forwarded to the storing component 38 for storing the user profiles. The plurality of authentication information (e.g., the different user profiles) stored in the storing component 38 indicate the applications hosted in the network which the user corresponding to the authentication information is allowed to access.

The determining component 34 is adapted to compare the received authentication information with the plurality of authentication information stored in the storing component 38. If the received authentication information corresponds to one of the plurality of authentication information stored in the storing component 38 (e.g., if the received user account and/or user profiles matches one the of user accounts and/or user profiles stored in the storing component 38), the determining component 34 identifies, in accordance with the authentication information which has been identified to correspond to the received authentication information, which applications the user (requesting access) is allowed to access. The determining component 34 forwards information indicating which applications the user is allowed to access to the remote access component 36. The remote access component then provides the remote access from the mobile terminal 10 only to the applications which the user is allowed to access (step 404). If the determining component 34 identifies, by comparing the received authentication information with the plurality of authentication information stored in the storing component 38, that the received authentication information does not correspond (does not match) with any of the stored authentication information, it denies the access, i.e. the user corresponding to the authentication information is not allowed to remotely access any of the applications hosted in the network 40.

FIG. 5 shows a second method embodiment performed in the mobile terminal 10 of FIG. 3 (the method can similarly also be carried out in the mobile terminal 20). At first, the requesting component 12 of the mobile terminal 10 is requesting remote access to the plurality of applications hosted in the network (step 502). For this purpose, the requesting component 12 is adapted to signal authentication information (e.g. information related to the user account and/or user profiles of a user of the mobile terminal 10) to the receiving component 32 of the authentication server. If remote access is allowed by the authentication server 30, e.g. as described above with respect to FIGS. 2 and 4, the obtaining component 14 is adapted to obtain remote access to the applications hosted in the network, to which the remote access has been allowed by the authentication server (step 504). Finally, one of the applications to which remote access has been obtained can be carried out (executed) by the executing component 16 (step 506). The last step is, however, only optional.

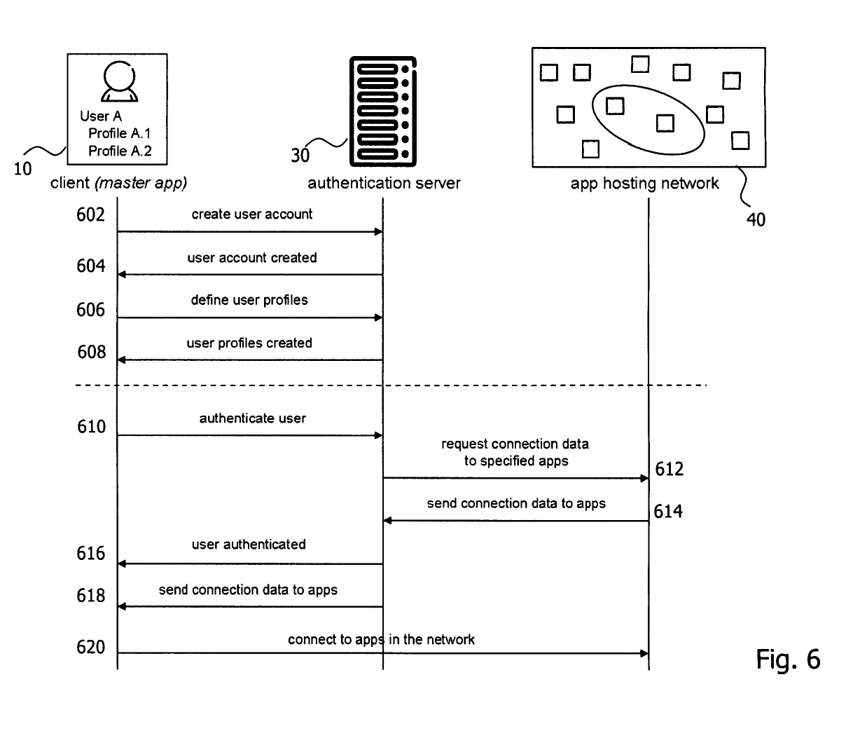

A flow chart illustrating the steps for user account creation, authentication and accessing the apps is given in FIG. 6. FIG. 6 schematically shows the mobile terminal 10 of FIG. 3, the authentication server 30 of FIG. 2 and the network 40. FIG. 6 exemplarily shows only one client, namely the mobile terminal 10 being attached to the authentication server 30 and via the authentication server 30 to the app hosting network 40. It goes without saying that multiple (not illustrated) clients may be connected or may connect to the authentication server 30, e.g. the mobile terminal 20 and further mobile terminals.

Steps 602 to 608 in FIG. 6 relate to the creation of a user account by means of and in the client, i.e. the mobile terminal 10.

The user first requests, in step 602, the creation of a user account for example using HTTP Digest or Basic Authentication towards the authentication server 30. The authentication server then confirms that the user account has been created (step 604). Afterwards, user profiles can be created for that user account (step 606). The user profiles are created by the users, usually on their clients, and contain information on the users' location, given timeframes (where the user is at what times) and any other type of information which can specify a need for a specific set of apps to be provided.

In the example shown in FIG. 6, two user profiles A.1 and A.2 are created by the user A. This is, however, merely exemplary and the user may create any number of user profiles for its user account, e.g. one, three, four, five, six, or more than six user profiles for the same user account. The user profiles A.1, A.2 do not necessarily have to be created on one specific client which is later used for accessing the applications. It is conceivable that the user creates a user account using a first client, e.g. a stationary client like a PC, and later accesses the user account using a second client, e.g. a mobile client like a smartphone (e.g., the mobile terminal 10), for obtaining remote access to the applications. Finally, the authentication server 30 confirms that the user profile(s) has/have been created (step 608).

The authentication and accessing procedure is performed in steps 610 to 620 after the user account and possibly also user profiles have been created in steps 602 to 608. The user authenticates itself at the authentication server 30 e.g. by inputting authentication information like a user name and a password (step 610). Other authentication procedures using voice recognition techniques are also conceivable and can be used independent from or in addition to the user input.

After successful authentication, the authentication server 30 establishes a connection to the network 40 hosting the apps in order to retrieve the connection data to the apps (steps 612 and 614) to which remote access is allowed in accordance with the authentication information. In step 616, a confirmation message is transmitted to the mobile terminal 10 to confirm that the user has been successfully authenticated. The authentication itself is, however, performed before the connecting data is requested and retrieved from the network 40. In FIG. 6, the step 616 (confirmation message) is carried out after the connection data is retrieved by the authentication server 30 (steps 612, 614). However, the confirmation message (step 616) may also be sent before the steps 612 and 614 for retrieving the connection data. These connection data may include URIs or URLs and are sent to the user's client by the Authentication Server (step 618).

The client through the master app has then the possibility to access the apps in the network e.g. via HTML (step 620).

To summarize these steps, the authentication server 30 may provide the main business logic of the present embodiments and act as a gateway between the end user (e.g., the mobile terminal 10, 20 as the client of the end user) and the cloud based network 40. The authentication server 30 authenticates an end user towards the network 40 and applies accessibility to the configured sets of apps. The authentication server 30 also maintains the user accounts and the corresponding user profiles A.1, A.2, B.1, B.2.

In particular embodiments, some or all of the functionality described above as being provided by the authentication server 30 or user devices may be provided by processors executing instructions stored on a computer-readable medium. Alternative embodiments may include additional components that may be responsible for providing certain aspects of the authentication server's 30 or user device's functionality, including any of the functionality described herein and/or any functionality necessary to support the solution described herein.

Further, the authentication server 30 can send information to the users on updates in apps related to the user profiles of each user or inform them on new apps. Change in the location of a user can be communicated to the authentication server 30 either manually from the user or automatically, based on a regular location update mechanism triggered by the user's client. This can in turn trigger the authentication server 30 to notify the client of new apps fitting to the profile change executed due to the location update.

There are some advantages coming along with the described embodiments.

First, the end-user does not have to take care on versioning of the apps. The latest version of an app will always be provided remotely by the network 40 and has not to be downloaded to the client, e.g. the mobile terminals 10, 20, manually.

Second, the app can be used independent of the client's operating system. Only one operating system native app (i.e. master app) has to be installed on the client, e.g. the mobile terminals 10, 20.

Furthermore, the configuration settings for an app when used on different devices can always be the same as they are also stored in the network 40.

The app providers also only have to publish one app for all devices and operating systems. That simplifies the development of an app a lot.

Then, the client, e.g. smartphone or Tablet PC, requires less hardware resources like memory and CPU as the business logic is executed in the network 40. This provides completely new opportunities and possibilities for app developers as the apps can be more complex and their hardware requirements can be larger.

Besides, the different profiles A.1, A.2 of a user account guarantee that only the apps are made available on the client, e.g. the mobile terminal 10, which are really needed at a certain point in time. Having this, the available apps can be accessed in a faster and easier way and also bandwidth can be saved.

In the end, the new network setup, i.e. hosting and executing apps in the network 40, also offers completely new business opportunities as the network 40 can be managed and run by operators who right now do not have business in smartphone apps except offering bandwidth for downloading the apps to the client.

The present disclosure solves this problem by applying another maintenance procedure with version control handled in the network 40, i.e. on the server side rather than client focused.

1. A method of providing remote access from a mobile terminal to a plurality of applications hosted in a network, wherein the method comprises the steps of:
determining, by an authentication server, based on authentication information received from the mobile terminal, whether to allow remote access from the mobile terminal to the network;
providing, by the authentication server, remote access from the mobile terminal to the plurality of applications hosted in the network, based on it being determined that the remote access is allowed, wherein the remote access allows executing the plurality of applications in the network; and
executing a selected application in the network rather than on the mobile terminal based on a user selection of any one of the applications hosted in the network via a master application installed on the mobile terminal.

2. The method of claim 1, wherein the determining step and the providing step comprise:
determining, by the authentication server based on the authentication information, a set of applications, wherein the set of applications comprises one or more of the plurality of applications hosted in the network; and
providing, by the authentication server, remote access from the mobile terminal only to the one or more applications contained in the set of applications.

3. The method of claim 2, wherein the step of determining the set of applications comprises at least one of determining the set of applications from one or more sets of applications maintained in the authentication server based on the authentication information and choosing the set of applications from the one or more sets of applications based on a user input of a user of the mobile terminal.

4. The method of claim 3, wherein at least a subset of the one or more sets of applications comprises different ones of the plurality of applications hosted in the network.

5. The method of claim 3, wherein at least a subset of the one or more sets of applications comprises the same of the plurality of applications hosted in the network.

6. The method of claim 3, wherein each of the one or more sets of applications are predefined in a user profile of a user account, wherein the user account is specific to a user of the mobile terminal and is maintained in the authentication server.

7. The method of claim 1, wherein the step of providing remote access includes the steps of requesting, by the authentication server, connecting data to the plurality of applications hosted in the network, based on it being determined that the remote access is allowed, retrieving, by the authentication server, the connecting data to the applications hosted in the network and transmitting, by the authentication server, the retrieved connecting data to the mobile terminal.

8. The method of claim, wherein the step of requesting connecting data comprises the step of requesting, by the authentication server, only the connecting data to the applications contained in the set of applications.

9. A method of obtaining remote access from a mobile terminal to a plurality of applications hosted in a network, wherein the method comprises the steps of:
requesting by the mobile terminal, remote access to the plurality of applications hosted in the network by signaling authentication information;
obtaining, by the mobile terminal, remote access to the plurality of applications hosted in the network, based on it being determined, based on the authentication information, that remote access is allowed, wherein the remote access allows executing the plurality of applications in the network;
selecting, by a user, any one of the applications hosted in the network via a master application installed on the mobile terminal so as to execute the selected application in the network rather than on the mobile terminal.

10. The method of claim 9, further comprising the step of executing, by the mobile terminal, one of the plurality of applications in the network after obtaining remote access to the plurality of applications.

11. The method of claim 9, further comprising the step of creating, by the mobile terminal, a user account in the authentication server, wherein the user account is accessible by means of the authentication information.

12. The method of claim 11, wherein the step of creating the user account further comprises creating one or more user profiles in the user account, wherein each of the one or more user profiles specifies a set of applications comprising one or more of the plurality of applications hosted in the network.

13. A computer program product comprising program code portions for performing the steps of claim 1 when the computer program product is run on a computer system.

14. The computer program product of claim 13, stored on a non-transitory computer-readable recording medium,

15. An authentication server for providing remote access from a mobile terminal to a plurality of applications hosted in a network, wherein the authentication server comprises:
a determining component adapted to determine based on authentication information received from the mobile terminal, whether to allow remote access from the mobile terminal to the network; and
a remote access component adapted to provide remote access from the mobile terminal to the plurality of applications hosted in the network, based on being determined that the remote access is allowed, wherein the remote access allows executing the plurality of applications in the network, and to execute a selected application in the network rather than on the mobile terminal based on a user selection of any one of the applications hosted in the network via a master application installed on the mobile terminal.

16. The server of claim 15, wherein the determining component is further adapted to determine based on the authentication information, a set of applications, wherein the set of applications comprises one or more of the plurality of applications hosted in the network, and the remote access component is further adapted to provide remote access from the mobile terminal only to the one or more applications contained in the set of applications.

17. The server of claim 16, wherein the server further comprises a storing component adapted to maintain one or more sets of applications and the determining component is further adapted to at least one of determine the set of applications from the one or more sets of applications based on the authentication information and to receive a user input of a user of the mobile terminal for choosing the set of applications from the one or more sets of applications.

18. The server of claim 17, wherein the storage component is further adapted to maintain one or more user profiles of a user account, wherein the user account is specific to a user of the mobile terminal and each of the one or more user profiles specifies one of the one or more sets of applications.

19. The server of claim 15, wherein the remote access component is further adapted to request connecting data to the plurality of applications hosted in the network, based on it being determined that the remote access is allowed, to retrieve the connecting data to the applications hosted in the network and to transmit the retrieved connecting data to the mobile terminal.

20. A mobile terminal for obtaining remote access to a plurality of applications hosted in a network, wherein the mobile terminal comprises:
a requesting component adapted to request remote access to the plurality of applications hosted in the network by signaling authentication information; and
an obtaining component adapted to obtain remote access to the plurality of applications hosted in the network, based on it being determined, based on the authentication information, that remote access is allowed, wherein the remote access allows executing the plurality of applications in the network, and to select, by a user, any one of the applications hosted in the network via a master application installed on the mobile terminal so as to execute the selected application in the network rather than on the mobile terminal.

21. The mobile terminal of claim 20, further comprising an executing component adapted to execute one of the plurality of applications hosted in the network.

22. A system for providing remote access from a mobile terminal to a plurality of applications hosted in a network, wherein the system comprises:
the network hosting a plurality of applications;
the authentication server of claim 15; and
a mobile terminal for obtaining remote access to a plurality of applications hosted in a network, wherein the mobile terminal comprises:
a requesting component adapted to request remote access to the plurality of applications hosted in the network by signaling authentication information; and
an obtaining component adapted to obtain remote access to the plurality of applications hosted in the network, based on it being determined, based on the authentication information, that remote access is allowed, wherein the remote access allows executing the plurality of applications in the network, and to select, by a user, any one of the applications hosted in the network via a master application installed on the mobile terminal so as to execute the selected application in the network rather than on the mobile terminal.
